(19) United States
(12) Patent Application Publication
(10) Pub. No.: US 2025/0132400 A1
(43) Pub. Date: Apr. 24, 2025

(54) NON-AQUEOUS SECONDARY LITHIUM-ION BATTERY CELL WITH A TRANSITION METAL TRAPPING METAL OXIDE

(71) Applicant: GM Global Technology Operations LLC, Detroit, MI (US)

(72) Inventor: Seung-Woo Chu, Sterling Heights, MI (US)

(21) Appl. No.: 18/491,978

(22) Filed: Oct. 23, 2023

(51) Int. Cl. H01M 10/42; H01M 10/0525; H01M 10/0583; H01M 10/0587; H01M 50/105; H01M 50/403; H01M 50/431; H01M 50/443; H01M 50/457; H01M 50/46; H01M 50/491

(52) U.S. Cl. CPC H01M 10/4235; H01M 10/0525; H01M 10/0583; H01M 10/0587; H01M 50/105; H01M 50/403; H01M 50/431; H01M 50/443; H01M 50/457; H01M 50/46; H01M 50/491; H01M 2220/20

(57) ABSTRACT

A method of forming a battery cell, a secondary lithium ion battery cell, and a secondary lithium ion battery cell for a vehicle. The secondary lithium ion battery cell including a cathode electrode including a lithium and a transition metal, an anode electrode, a porous separator sandwiched between the cathode electrode and the anode electrode, an electrolyte permeated in the porous separator and contacting the cathode electrode and anode electrode, and a zeolite particle layer between the porous separator and at least one of the cathode electrode and the anode electrode.

### INTRODUCTION

Electric and hybrid electric vehicle technology has been enabled by the development and deployment of rechargeable, secondary batteries which provide energy to the powertrain. Secondary batteries include lithium ion batteries, which generally include a cathode, anode, separator, and electrolyte. The cathode provides the source of lithium ions determining the capacity and average voltage of a battery. The anode stores and releases lithium ions received from the cathode. The separator prevents the cathode and anode from contacting. The electrolyte provides a medium between the cathode and anode through which the lithium ions travel.

Lithium cathodes including transition metals, and in particular, manganese, have been introduced, such as lithium ion manganese oxide (LMO), lithium manganese (LNMO), lithium- and manganese-rich (LMR), and lithium ferro manganese phosphate (LFMP) cathodes. However, transition metals, such as manganese, are subject to transition metal dissolution during lithium ion insertion and extraction due to the Jahn-Teller effect, a distortion of a non-linear molecular system, reducing its symmetry and energy, during lithium ion insertion and extraction. One solution for addressing the transition metal dissolution is to trap the dissolved transition metal in the battery electrolyte. Efforts have been made to incorporate zeolites into the battery structure to trap the transition metals using binder materials or powder coating the zeolite onto various components of the battery cell. However, these efforts are complicated by the hydrophilic nature of zeolites. Due to their relatively large surface area, the zeolites readily uptake significant amounts of water, increasing the electrical conductivity of the zeolites and also introducing water into the battery system.

Thus, while present secondary lithium-ion battery cells achieve and batteries their intended purpose, there is a need for new and improved secondary lithium-ion battery cells.

### SUMMARY

According to several aspects, the present disclosure relates to a method of forming a battery cell. The method includes dispersing a plurality of zeolite particles in a non-aqueous solvent to form a zeolite dispersion. The method also includes supplying a cathode electrode and an anode electrode, wherein the cathode electrode includes a cathode and a cathode current collector, and the anode electrode includes an anode and an anode current collector. The method also includes arranging a porous separator at least partially between the cathode electrode and the anode electrode. In addition, the method includes dispensing the zeolite dispersion between the porous separator and at least one of the cathode and the anode, forming a zeolite particle layer, and sandwiching the porous separator and the zeolite particle layer between the cathode electrode and the anode electrode.

According to embodiments of the above, the zeolite particles are present in the solvent in the range of 0.1 percent by mass to 30 percent by mass of the total mass of the zeolite dispersion.

In any of the above embodiments, the zeolite dispersion includes a surfactant present in the range of 0.1 percent by mass to 2 percent by mass of the total mass of the zeolite dispersion.

In any of the above embodiments, the zeolite dispersion does not include a polymeric binder.

In any of the above embodiments, the non-aqueous solvent exhibits a boiling point of less than 120 degrees Celsius.

In any of the above embodiments, the method further includes evaporating the non-aqueous solvent from the zeolite dispersion.

In any of the above embodiments, the battery cell is for use in a battery and the battery includes an electrolyte and the non-aqueous solvent is the electrolyte.

In any of the above embodiments, arranging a porous separator at least partially between the cathode electrode and the anode electrode includes interleaving a cathode electrode within a first fold of the porous separator and interleaving an anode electrode within a second fold of the porous separator. In further embodiments, dispensing the zeolite dispersion includes spraying the zeolite dispersion on a first side of the porous separator that contacts the cathode electrode. In alternative or additional embodiments, dispensing the zeolite dispersion includes spraying the zeolite dispersion on a second side of the porous separator that contacts the anode electrode.

Alternatively to arranging a porous separator at least partially between the cathode electrode and the anode electrode includes interleaving a cathode electrode within a first fold of the porous separator and interleaving an anode electrode within a second fold of the porous separator in any of the above embodiments, arranging a porous separator at least partially between the cathode electrode and the anode electrode includes winding a first separator ribbon, a cathode electrode ribbon, a second separator ribbon, and an anode electrode ribbon around a mandrel. In further embodiments, arranging a porous separator at least partially between the cathode electrode and the anode electrode includes winding a first separator, a cathode electrode, a second separator, and an anode electrode around a mandrel. In further embodiments, dispensing the zeolite dispersion includes spraying the zeolite dispersion between the first separator and the cathode electrode, wherein the first separator is positioned between the cathode electrode and the anode electrode. In yet additional or alternative embodiments, dispensing the zeolite dispersion includes spraying the zeolite dispersion between the first separator and the anode electrode.

In any of the above embodiments, the method includes placing the battery cell in a pouch, adding an electrolyte to the pouch, and sealing the pouch.

According to additional aspects, the present disclosure relates to a secondary lithium ion battery cell for a vehicle. The battery cell includes a cathode electrode including a lithium and a transition metal, an anode electrode, a porous separator sandwiched between the cathode electrode and the anode electrode, an electrolyte permeated in the porous separator and contacting the cathode electrode and anode electrode, and a zeolite particle layer between the porous separator and at least one of the cathode electrode and the anode electrode. In embodiments, the zeolite particle layer does not include a binder the zeolite particle layer in the battery cell.

In embodiments of the above, the zeolite particle layer is in the range of 0.5 micrometers to 2 micrometers and exhibits a porosity in the range of 10 percent to 90 percent of the total volume defined by the zeolite particle layer.

In any of the above embodiments, the zeolite particle layer includes zeolite particles exhibit one or more specific surface areas, determined using BET (Brunauer, Emmett and Teller) theory technique, of over 100 meters squared per gram.

In any of the above embodiments, the zeolite exhibits the formula Mⁿ⁺_{1/n}(AlO₂)—(SiO₂)ₓ*yH2O, where Mⁿ⁺_{1/n} is one of a metal ion and a hydrogen ion, x is in the range of 1 to 30, n is the charge of the metal particle and may be in the range of 1 to 3 and y is in the range of 1 to 100.

According to yet additional aspects, the present disclosure relates to a secondary lithium ion battery for a vehicle. The battery includes a casing and one or more battery cells sealed in a pouch and stacked in the casing. The battery cells include a cathode electrode including a cathode formed of lithium and a transition metal, an anode electrode, a porous separator sandwiched between the cathode electrode and the anode electrode, an electrolyte permeated in the porous separator and contacting the cathode electrode and anode electrode, and a zeolite particle layer between the porous separator and at least one of the cathode electrode and the anode electrode. The zeolite particle layer does not include a binder for bonding the zeolite particle layer in the battery cell. The battery also includes an anode tab connected to a portion of the anode electrode extending out of the pouch and a cathode tab connected to a portion of the cathode electrode extending out of the pouch.

### BRIEF DESCRIPTION OF DRAWINGS

The drawings described herein are for illustration purposes only and are not intended to limit the scope of the present disclosure in any way.

FIG. 1 illustrates a vehicle including a propulsion system utilizing a battery according to the various embodiments described herein.

FIG. 2A illustrates a battery including a non-aqueous secondary lithium ion battery cell including a transition metal trapping metal oxide, according to various embodiments described herein.

FIG. 2B illustrates a battery cell including a transition metal trapping metal oxide, according to various embodiments described herein.

FIG. 3A illustrates an arrangement of a lithium ion battery cell including a transition metal trapping metal oxide, according to various embodiments described herein.

FIG. 3B illustrates an arrangement of a lithium ion battery cell including a transition metal trapping metal oxide, according to various embodiments described herein.

FIG. 3C illustrates an arrangement of a lithium ion battery cell including a transition metal trapping metal oxide, according to various embodiments described herein.

FIG. 4 illustrates a method of forming a lithium ion battery cell including a transition metal trapping metal oxide, according to various embodiments described herein.

FIG. 5 illustrates a system of manufacturing a lithium ion battery cell including a transition metal trapping metal oxide, according to various embodiments described herein.

FIG. 6 illustrates a system of manufacturing a lithium ion battery cell including a transition metal trapping metal oxide, according to various embodiments described herein.

FIG. 7A illustrates a system of manufacturing a lithium ion battery cell, according to various embodiments described herein.

FIG. 7B illustrates a system of manufacturing a lithium ion battery cell, according to various embodiments described herein.

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale.

The present disclosure is related to a non-aqueous secondary lithium-ion battery cell with a transition metal trapping metal oxide, batteries including such battery cells, and vehicles including such batteries, as well as systems for and methods of manufacturing batteries containing transition metal containing cathodes as well as zeolite particle layers for trapping transition metal ions liberated from the cathodes.

As used herein, the term “vehicle” is not limited to automobiles. While the present technology is described primarily herein in connection with electric vehicles, the technology is not limited to electric vehicles, but hybrid electric vehicles as well. In addition, the concepts can be used in a wide variety of applications, such as in connection with components used in motorcycles, mopeds, locomotives, aircraft, marine craft, and other vehicles, as well as in other applications utilizing batteries, such as in portable power stations, such as those used for powering remote job sites and emergency back-up power supplies, and permanent power stations associated with buildings and equipment, all of which may be powered by, for example, solar or wind-powered generator systems, power mains, and fuel based power generators such as gasoline or diesel generators as well as sterling engines.

FIG. 1 illustrates a vehicle 100 including a propulsion system 120. The propulsion system 120 generally includes an electric motor 124 and a secondary battery 126 for powering the electric motor 124. Further, in many embodiments of the propulsion system 120, the propulsion system 120 includes an inverter 128 for changing power from DC (direct current) as provided by the battery 126 to AC (alternating current) as it is used by the electric motor 124. The inverter 128 may be included in a power electronics module 130, which includes e.g., transistors and diodes, for switching the power from DC to AC and vice-versa.

A controller 132 is connected to the inverter 128 and is programmed to control and manage the operations of the electric motor 124 and associated hardware, including the inverter 128. The electric motor 124 is connected to a transmission (drive unit) 136, and drive line 138, which transfers mechanical power and rotation to the wheels 140 of the vehicle 100. The controller 132 includes one or more one or more processors and tangible, non-transitory memory 134.

With reference again to the electric motor 124, the electric motor 124, powered by the battery 126, includes a stator 142 and a rotor 144 arranged with the stator 142. The stator 142 is the stationary part of the electric motor 124. The stator 142 provides a rotating magnetic field with which the stationary magnetic field of the rotor 144 tries to align with, causing the rotor 144 to rotate, in what may be referred to as “motoring” mode. In other applications the rotor's 144 rotating field (as caused by physical rotation) generates an electric current in the stator 142—this mode of operation is referred to as “generation” and the electric motor 124 used in this way is referred to as generator. In traction motor vehicle applications, the motoring mode provides motion to the vehicle 100. Generation mode takes some of the energy recovered from braking when the vehicle is in the process of stopping and stores it back in the vehicle battery 126.

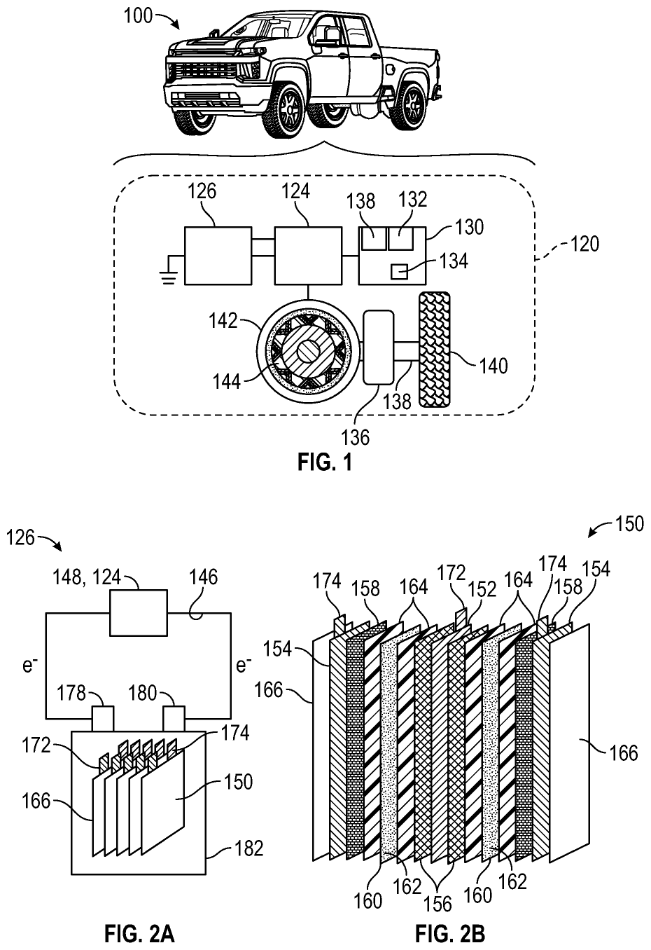

Reference is made to FIGS. 2A and 2B as well as 3A through 3C, illustrating an example of a secondary battery 126 for powering an electric vehicle 100, such as the electric vehicle 100 illustrated in FIG. 1. Referring to FIG. 2A, the battery 126 is illustrated as being connected to a load 148, such as the electric motor 124. As noted above, secondary batteries are understood as rechargeable batteries, that may be discharged upon application of a load and recharged upon the application of an external power source. The battery 126 includes one or more battery cells 150, that are assembled together. Each battery cell 150, as illustrated in FIG. 2B, generally includes a cathode current collector 152, an anode current collector 154, a cathode 156, an anode 158, a separator 160, and electrolyte 162 as well as a zeolite particle layer 164 for trapping transition metal ions, such as Mn+. While the illustrated battery cell 150 includes two anode current collectors 154 and one cathode current collector 152, the battery cell 150 may alternatively include two cathode current collectors 152 and one anode current collector 154, or one cathode current collector 152 and one anode current collector 154. In addition, while a zeolite particle layer 164 is provided on either side of each separator 160 illustrated, the zeolite particle layers 164 may be provided on either side of the separator 160 as described further herein. During discharge, when the battery 126 is powering a load 124, Li+ ions move from the anode 158 to the cathode 156 through the separator 160 by way of the electrolyte 162. Equivalent electrons e− move through the circuitry 146 from the cathode 156 to the anode 158, providing voltage to the load 124. While charging, upon application of an external voltage, Li+ ions move from the cathode 156 to the anode 158 by way of the electrolyte 162 through the separator 160 and may be intercalated into the anode 158.

The cathode current collector 152 and anode current collector 154 are formed from conductive materials. In embodiments, the cathode charge current collector 152 may include one or more of aluminum, nickel, and stainless steel; and the anode current collector 154 may include one or more of copper, nickel, stainless steel, and titanium. The current collectors 152, 154 are illustrated as being in the form of a foil; however, it should be appreciated that other forms may be exhibited. The cathode current collector 152 and anode current collector 154 are impermeable to gas. In embodiments, the cathode current collector 152 exhibits a thickness in the range of 5 micrometers to 50 micrometers, including all values and ranges therein, such as in the range of 8 micrometers to 25 micrometers, and the anode current collector 154 exhibits a thickness in the range of 5 micrometers to 50 micrometers, including all values and ranges therein, such as in the range of 8 micrometers to 25 micrometers.

The cathode 156 includes materials that provide a source of lithium ions (Li+) and can undergo reversible insertion or intercalation of lithium ions, determining the capacity and average voltage of a battery. The cathode materials include lithium and a transition metal, such as manganese. In embodiments, the cathode 156 if formed from one or more of LiMeO₂, LiMeO₄, LiMePO₄, wherein Me is a transition metal, and in aspects, includes manganese alone or in combination with other transition metals such as nickel and iron. In embodiments, the cathode 156 includes at least one of a lithium ion manganese oxide (LMO), lithium manganese nickel oxide (LMNO), lithium-rich manganese oxide (LMR), lithium nickel manganese cobalt oxide, and lithium ferro-manganese phosphate (LFMP) cathodes as well as in other chemistries including transition metals such as cobalt, vanadium, aluminum, etc. The cathode 156 exhibits a thickness in the range of 50 micrometers to 150 micrometers, including all values and ranges therein. In embodiments, the cathode 156 is applied to the cathode current collector 152 as a coating using a deposition process, such as a slurry based process, hot roll pressing process, extrusion or additive manufacturing. The combined cathode 156 and cathode current collector 152 provide a cathode electrode, as referenced further herein. In embodiments, the cathode electrode exhibits a thickness in the range of 100 micrometers to 300 micrometers, including all values and ranges therein.

The anode 158 includes materials that can undergo reversible insertion or intercalation of lithium ions at a lower electrochemical potential than the cathode 156 material, such that an electrochemical potential difference exists between the anode 158 and cathode 156. The anode material may include one or more of lithium metal; alloys of lithium such as lithium silicon alloy, lithium aluminum alloy, lithium indium alloy, lithium titanate, and lithium tin alloy; carbon based materials such as graphite, activated carbon, carbon black and graphene; silicon; silicon based alloys; silicon-oxide; silicon based composite materials; tin oxide; aluminum; indium; zinc; germanium; and titanium oxide; as well as any combination of the above. In embodiments, the anode 158 exhibits a thickness in the range of 50 micrometers to 150 micrometers, including all values and ranges therein. In embodiments, the anode 158 is applied to the anode current collector 154, forming a coating on the anode current collector 154, using a deposition process, such as a slurry based process, hot roll pressing process, extrusion or additive manufacturing. The combined anode 158 and anode current collector 154 provide an anode electrode, as referenced further herein.

The separator 160 is a porous material formed of an electrically insulative material that prevents the cathode 156 and anode 158 from contacting and potentially shortening out the circuit. The separator 160 is sandwiched, or at least partially enclosed, between the cathode 156 and anode 158, allowing the passage of the lithium ions and electrolyte 162 through the pores of the separator 160. The separator 160 may include one or more of a composite, a polymeric material, and a non-woven material. In embodiments, the separator includes at least one of polyethylene, polypropylene, polyamide, polytetrafluoroethylene, polyvinylidene fluoride, and polyvinyl chloride. In addition, the separator 160 may be filled, i.e., include fillers dispersed therein, wherein the filler includes a material such as glass fiber. In additional or alternative embodiments, the separator 160 may include at least one of a thermally stable, porous polymer coating and a ceramic coating such as an alumina coating. The coating is disposed on one or more surfaces of a porous polymer film, the polymer film being selected from at least one of polyethylene and polypropylene. The separator 160 may include one or more layers, wherein each layer is formed from one or more of the materials noted above. The separator 160 may take the form of film or a mesh, such as woven mesh or a slit film. In embodiments, the separator 160 exhibits a thickness in the range of 4 micrometers to 25 micrometers, including all values and ranges therein.

The electrolyte 162 provides a medium between the cathode 156 and anode 158 through which lithium ions and the electrolyte travel. The medium may be a liquid, gel, or solid, and capable of conducting the lithium ions between the cathode 156 and the anode 158. The electrolyte 162 permeates the pores of the porous separator 160 and wets the surfaces of the cathode 156 and anode 158 as well as the separator 160. In embodiments, the electrolyte 162 is a non-aqueous organic solvent. In further embodiments, the electrolyte 162 is a non-aqueous aprotic organic solvent including or more of various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxy ethane), cyclic ethers (e.g., tetrahydrofuran, 2-methyltetrahydrofuran), 1,3-dioxolane).

In any of the above embodiments, the electrolyte 162 may include a lithium salt dissolved in the one or more organic solvents. The lithium salts may include one or more of the following: lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane) sulfonylimide (LiN(CF₃SO₂)₂), lithium bis(fluorosulfonyl) imide (LiN(FSO₂)₂) (LiSFI), lithium (triethylene glycol dimethyl ether)bis(trifluoromethanesulfonyl)imide (Li(G3)(TFSI), and lithium bis(trifluoromethanesulfonyl) azanide (LiTFSA). The lithium salt may be present in the electrolyte 162 at a concentration (moles of salt per liter of solvent) ranging from 1 M to 4 M, including all values and ranges therein, such as 2 M or 3 M.

Further, the electrolyte 162 may include a number of additives, such as, but not limited to vinyl carbonate, vinyl-ethylene carbonate, propane sulfonate, and combinations thereof. Other additives can include diluents which do not coordinate with lithium ions but can reduce viscosity of the electrolyte 162, such as bis(2,2,2-trifluoroethyl) ether (BTFE), and flame retardants, such as triethyl phosphate.

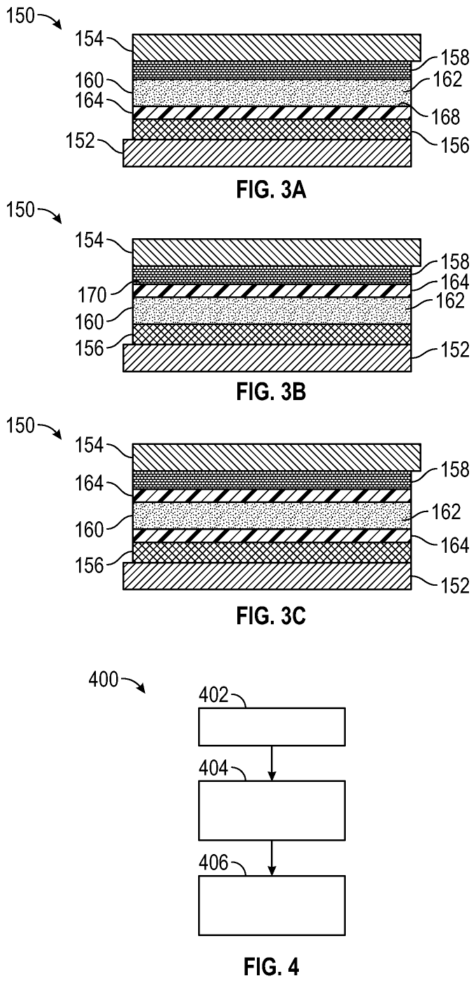

FIGS. 3A, 3B and 3C illustrate embodiments of one or more zeolite particle layers 164 incorporated into the battery cells 150 described above. As mentioned above, the zeolite particles trap transition metals ions that are released from the cathode 156 during lithium ion insertion and extraction. In addition to trapping transition metal ions the zeolite also absorbs moisture that may be present in the battery cell 150. The zeolite particles that provide the zeolite particle layer 164 are generally understood as microporous, crystalline aluminosilicate materials. The zeolite particles exhibit one or more specific surface areas, determined using BET (Brunauer, Emmett and Teller) theory technique, of over 100 meters squared per gram, such as in the range of 100 meters squared per gram to 500 meters squared per gram, including all values and ranges therein. The zeolite may exhibit the general formula Mⁿ⁺_{1/n}(AlO₂)—(SiO₂)ₓ*yH2O, where Mⁿ⁺_{1/n} is one of a metal ion, such as a lithium ion (Li+), or a hydrogen ion (H⁺), n is the charge of the metal particle and may be in the range of 1 to 3, x is in the range of 1 to 30, y is in the range of 1 to 100. In embodiments, the zeolite may exhibit a Si to Al atomic ratio in the range of 1:1 to 30:1 or greater. In embodiments, the Si to Al atomic ratio is greater than 5:1 and includes a framework selected from one or more of the following: ASU-7 (ASV), Zeolite-Beta (BEA), CIT-5 (CFI), CIT-1 (CON), Deca-dodecasil 3R (DDR), Dodecasil 1H (DOH), UTD-1F (DON), ERS-7 (ESV), EU-1 (EUO), Ferrierite (FER), GUS-1 (GON), ITQ-4 (IFR), ITQ-7 (ISV), ITQ-3 (ITE), Levyne (LEV), ZSM-11 (MEL), Melanophlogite (MEP), ZSM-5 (MFI), ZSM-57 (MFS), MCM-61 (MSO), MCM-35 (MTF), ZSM-39 (MTN), ZSM-23 (MTT), ZSM-12 (MTW), MCM-22 (MWW), nonasil (NON), NU-87 (NES), RUB-17 (RSN), RUB-3 (RTE), RUB-13 (RTH), RUB-10 (RUT), SSZ-48 (SFE), SSZ-44 (SFF), Sigma-2 (SGT), Sodalite (SOD), SSZ-35 (STF), SSZ-23 (STT), Terranovaite (TER), Theta-1 (TON), VPI-8 (VET), VPI-9 (VNI), and VPI-7 (VSV).

As illustrated in FIG. 3A, in embodiments, the zeolite particle layer 164 is applied between the cathode 156 and the cathode side 168 of the separator 160. In alternative, or additional embodiments, illustrated in FIG. 3B, the zeolite particle layer 164 is applied between the anode 158 and the anode side 170 of the separator 160. In further embodiments, illustrated in FIG. 3C, zeolite particle layers 164 are applied between both the cathode 156 and the cathode side 168 of the separator 160 and the anode 158 and the anode side 170 of the separator 160. The zeolite particle layer 164 may exhibit a thickness of less than 10 micrometers, such as in the range of 0.5 micrometer to 2 micrometers including all values and ranges therein. In the various aspects disclosed herein, the zeolite particle layer 164 does not include a polymeric binder or other adhesive; nor is a polymeric binder or adhesive used to adhere the zeolite particle layer 164 to surrounding layers. In addition, in embodiments, the zeolite particle layers 164 may cover the entire, or only a portion of the interface between the zeolite particle layers 164 and the cathode 156, the anode 158, or both the cathode 156 and anode 158 depending on which layers the zeolite particle layer 164 has been provided between. Further, in embodiments, the zeolite particle layer 164 exhibits a porosity in the range of 10 percent to 90 percent of the total volume defined by the zeolite particle layer 164. Porosity is understood herein as a measure of the volume of void space present in the total volume defined by a given layer, in this case the zeolite particle layer 164. It may be appreciated that if porosity is too high, such as greater than 90 percent, the effectiveness of the zeolite particle layer 164 is reduced, and if the porosity is too low, such as less than 10 percent, it may increase the resistance of the battery cell, reducing its overall power performance.

Referring again to FIG. 2B, in embodiments, the battery cells 150 are separated by the separator 160, which may wrap, at least partially, around each battery cell 150. Further, the battery cells 150 are sealed in a pouch 166 to seal the battery cells 150 from the ingress of water and other compositions that may damage the battery cells 150. In embodiments, a portion of the cathode current collector 152 extends out of the pouch 166 and is affixed to a cathode tab 172 that connects the cathode current collector 152 to a cathode bus bar 178. In addition, a portion of the anode current collector 154 extends out of the pouch 166 and is affixed to an anode tab 174 that is connected to an anode bus bar 180. The bus bars 178, 180 are then connected, directly or indirectly, to the load 148.

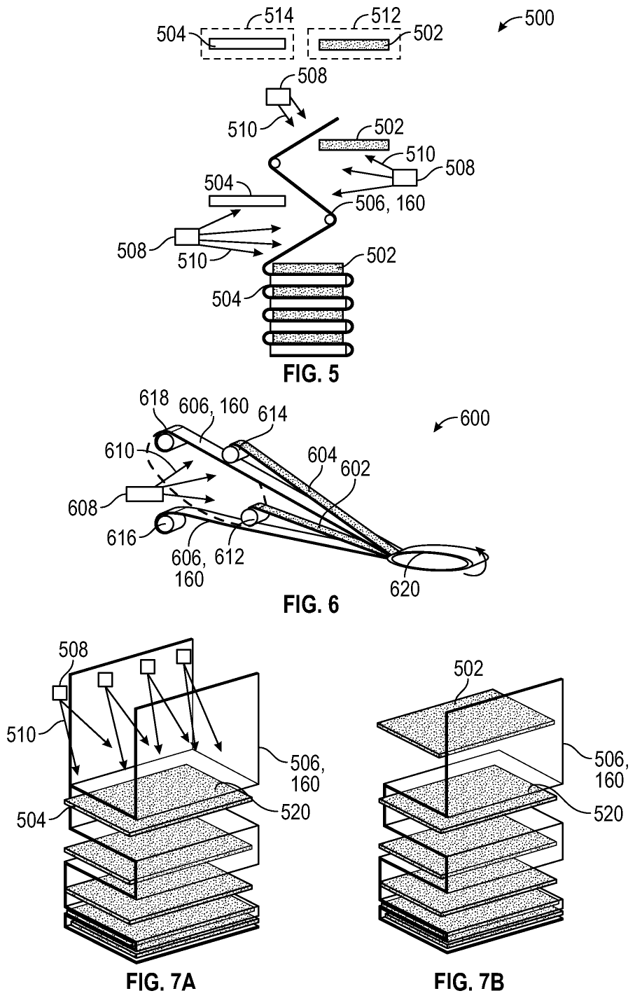

Turning now to FIG. 4, a method 400 of forming a battery cell 150 including one or more zeolite particle layers 164 is described with further reference to FIGS. 5 through 7, which illustrate systems 500, 600 for manufacturing the battery cells. To apply the zeolite particle layers 164 in the battery cells 150, at block 402 the zeolite particles are dispersed in a non-aqueous solvent to form a zeolite dispersion. In embodiments, the zeolite particles are present in the solvent in the range of 0.1 percent by mass to 30 percent by mass of the total mass of the dispersion, including all values and ranges therein. The dispersion of the zeolite particles in the solvent may assist in maintaining relatively low moisture levels of the zeolite particles. In embodiments, moisture content is less than 550 ppm of the total zeolite mass, excluding the solvent mass.

In embodiments, the non-aqueous solvent includes an organic solvent that exhibits a relatively low boiling point, allowing the solvent to evaporate at ambient temperatures and pressures. The solvents include, in embodiments, solvents that exhibit a boiling point of 120 degrees Celsius or less at standard atmospheric pressure, i.e., 101.3 kPa. In further embodiments, the solvent is one or more of dichloromethane, acetone, acetonitrile, ammonia, isopropyl alcohol, n-Propanol, ethanol, methanol, formic acid, n-butanol, acetic acid, and nitromethane. As may be appreciated, such ambient temperatures and pressures may change, depending on where the process is being performed and solvent selection may be adjusted based on process location.

In additional or alternative embodiments, the solvent is the same material as selected for the electrolyte 162 used in the battery cells 150. In embodiments, the solvent includes one or more aprotic organic solvents including one or more of various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxy ethane), and cyclic ethers (e.g., tetrahydrofuran, 2-methyltetrahydrofuran), 1,3-dioxolane). It may be appreciated that in utilizing solvents that are the same as the electrolyte 162, the wetting time of the battery 126, i.e., the time it takes for the electrolyte 162 to permeate the separator 160 and the wet the surfaces of the cathode 156 and anode 158 after assembly and introduction of the electrolyte 162, may be reduced.

The zeolite dispersion may also include, in any of the above embodiments, a surfactant that reduces the surface tension of the solvent and improves the wettability of the solvent on the surfaces in the battery cell 150. The surfactants may include, for example, lithium dodecyl sulfate (LiDs), polyoxyethylene ether, and lithium perfluorooctane sulfonate. In embodiments, the surfactant is present in a range of 0.1 percent by mass to 2 percent by mass of the total mass of the zeolite dispersion, including all values and ranges therein. It is noted, however, that a binder or other adhesive is not utilized in the zeolite dispersion to secure the zeolite particles onto surfaces in the battery cell 150.

At block 404, the battery 126 is assembled and the zeolite dispersion is applied to surfaces in the battery cell 150 as the battery cells 150 are being assembled. The battery cells 150 may be assembled using one or more of several systems, which interleave the cathode electrodes, including the cathode 156 and the cathode current collector 152, and anode electrodes, including the anode 158 and the anode current collector 154, with the separator, including the z-folding system 500, illustrated in FIG. 5, or jelly roll system 600 illustrated in FIG. 6. In these processes, the zeolite dispersion 510, 610 is applied using dispensers 508, 608 as the cathode electrodes 502, 602 and the anode electrodes 504, 604 are being assembled into the battery cell 150 with the separator 506, 606, 160. The dispensers 508, 608 include, for example, one or more spray nozzles located within in the assembly systems 500, 600.

For example, in embodiments a z-folding system 500 is used to assemble the battery cell 150. FIGS. 5, 7A and 7B illustrate an embodiment of the z-folding 500. During z-folding, the cathode electrodes 502 and anode electrodes 504 are moved from a cathode electrode supply 512 and anode electrode supply 514 and interfolded with a separator 506, 160, which assumes the shape of a ribbon. In embodiments, prior to placement of a cathode electrode 502 onto the separator 506, 160, the zeolite dispersion 510 is dispensed from one or more dispensers 508 in the form of spray heads, forming a zeolite particle layer 164 on the surface of separator 506 that will contact the cathode electrode 502. The cathode electrode 502 is then placed on the separator 506, 160, which is then wrapped over the cathode electrode 502. The anode electrode 504 is then placed sandwiching the separator between the cathode electrode 502 and the anode electrode 504. The separator 506 is then folded back over the anode electrode 504. This forms a zeolite arrangement similar to that illustrated in FIG. 3A. Instead of, or in addition to, dispensing the zeolite dispersion 510 prior to placement of the cathode electrode 502, the zeolite dispersion 510 is sprayed on the other side of the separator 506, 160 prior to placement of the anode electrode 504 to form a zeolite particle layer 164, which forms an arrangement similar to that illustrated in FIG. 3B or FIG. 3C (if the zeolite dispersion is dispensed on both surfaces of the separator 506). The process is then repeated until the desired number of layers of cathode electrodes 502 and anode electrodes 504 are assembled into the battery cell 150. It should be appreciated that, in embodiments, the zeolite dispersion 510 may be applied once per cycle, such as just before the cathode electrode 502 or the anode electrode 504 is inserted into the z-fold assembly 500. Further, it may be appreciated that the dispensers 508 may be adjusted to apply the zeolite dispersion 510 to specific locations on the separator 506, such that the zeolite dispersion 510 contacts only one surface of either the cathode electrode 502 or the anode electrode 504.

In alternative embodiments, reference is made to FIG. 6, which illustrates a jelly-roll winding system 600. During rolling, the cathode electrodes 602 and anode electrodes 604 are in the form of a ribbon and unwound from a cathode electrode supply 612 and anode electrode supply 614, respectively. A first separator 606, in the form of a ribbon, to be sandwiched between the cathode electrode 602 and the anode electrode 604 is unwound from a first separator supply 616. A second separator 606 located on either side of the cathode electrode 602, the first separator 606, and anode electrode 604, is also provided and unwound from a second separator supply 618. The four ribbons, i.e., the cathode electrode 602, the anode electrode 604, and the two separators 606 are wound around a mandrel 620. The zeolite dispersion 610 is dispensed from one or more dispensers 608 in the form of spray heads between the first separator 606 and the cathode electrode 602, between the first separator 606 and the anode electrode 604, or between the first separator 606 and the cathode electrode 602 and between the first separator 606 and the anode electrode 604. After the zeolite dispersion 610 is dispensed, the cathode electrode 602, anode electrode 604, and separators 606 are contacted together so as to interleave separators 606 and the zeolite particle layers 164 between the layers of the cathode electrode 602 and anode electrode 604 in the roll.

It should be appreciated that, if a low boiling point solvent is selected for the zeolite dispersion solvent, the low boiling point solvent is provided time to evaporate from the surfaces on which it is applied, prior to enclosing the zeolite particle layer 164 and separator 506, 606, 160 between the cathode electrode 502, 602 and anode electrode 504, 604 layers. Alternatively, or additionally, the solvent may be evaporated after assembling the battery cell 150 by baking the battery cell 150 in an oven under low pressure, such as a pressure less than standard atmospheric pressure. Alternatively, if the solvent selected for the zeolite dispersion 510, 610 is the same solvent as the electrolyte 162, then the processes may occur without waiting for the solvent to evaporate.

After assembly of the cathode electrodes 502, 602, the anode electrodes 504, 604, and the separators 506, 606, the individual battery cells 150 are placed in a pouch 166. The pouch 166 is formed from a non-conductive material, such as thermoplastic film. In embodiments, the thermoplastic film includes polyethylene or polypropylene. At block 406, in embodiments, the electrolyte 162 (see FIG. 2B) is added to the pouches 166, if needed, and the pouch 166 is sealed. Optionally, the pouches 166 are stored for later assembly, or assembled in the battery casing 182.

In embodiments, the method 400 described above may occur at −40 degrees Celsius dew point and at a relative humidity of 1%. Further, once the cathode electrodes 502, 602 and anode electrodes 504, 604 are assembled with the separators 506, 606, 160, the ability of moisture to ingress into the assembly is greatly reduced as the cathode current collector 156 and the anode current collector 154 provide a moisture barrier to the zeolite particle layer 164 as, after assembly, only the edges of the battery cells 150 are exposed to the environment, and the edges of the battery cell 150 and zeolite particle layers 164 exhibit significantly less surface area than the sandwiched surfaces of the zeolite particle layer 164.

The methods and systems herein offer a number of advantages. These advantages include, for example, the provision of a transition metal ion trap between the cathode and the anode electrodes to capture the dissolved transition metal ions without the introduction of extra moisture from the battery manufacturing environment. The elimination of the need for a binder or adhesive to hold the zeolites on the separators, cathodes and anodes prior to assembly of the battery cells. An additional advantage is the utilization of the moisture impermeable cathode current collector and anode current collector to prevent moisture from contacting the zeolite during the battery assembly. Yet an additional advantage when utilizing the same solvents in the zeolite dispersion as used in the electrolyte is the ability of the solvents to wet the cathode electrode, anode electrode, and separators and potentially reduce the overall wetting time that is typical of the process.

As used herein, the term “controller” and related terms such as microcontroller, control module, module, control, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.). The controller 132 may also consist of multiple controllers which are in electrical communication with each other. The controller 132 may be inter-connected with additional systems and/or controllers of the vehicle 100, allowing the controller 132 to access data such as, for example, speed, acceleration, braking, and steering angle of the vehicle 100.

A processor may be a custom made or commercially available processor, a central processing unit (CPU), a graphics processing unit (GPU), an auxiliary processor among several processors associated with the controller 132, a semiconductor-based microprocessor (in the form of a microchip or chip set), a macroprocessor, a combination thereof, or generally a device for executing instructions.

The tangible, non-transitory memory 134 may include volatile and nonvolatile storage in read-only memory (ROM), random-access memory (RAM), and keep-alive memory (KAM), for example. KAM is a persistent or non-volatile memory that may be used to store various operating variables while the processor is powered down. The tangible, non-transitory memory 134 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 132 to control various systems of the vehicle 100.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method of forming a battery cell, comprising:
dispersing a plurality of zeolite particles in a non-aqueous solvent to form a zeolite dispersion;
supplying a cathode electrode and an anode electrode, wherein the cathode electrode includes a cathode and a cathode current collector, and the anode electrode includes an anode and an anode current collector;
arranging a porous separator at least partially between the cathode electrode and the anode electrode;
dispensing the zeolite dispersion between the porous separator and at least one of the cathode and the anode;
forming a zeolite particle layer; and
sandwiching the porous separator and the zeolite particle layer between the cathode electrode and the anode electrode.

2. The method of claim 1, wherein the zeolite particles are present in the solvent in the range of 0.1 percent by mass to 30 percent by mass of the total mass of the zeolite dispersion.

3. The method of claim 2, wherein the zeolite dispersion includes a surfactant present in the range of 0.1 percent by mass to 2 percent by mass of the total mass of the zeolite dispersion.

4. The method of claim 2, wherein the zeolite dispersion does not include a polymeric binder.

5. The method of claim 2, wherein the non-aqueous solvent exhibits a boiling point of less than 120 degrees Celsius.

6. The method of claim 5, further comprising evaporating the non-aqueous solvent from the zeolite dispersion.

7. The method of claim 2, wherein the battery cell is for use in a battery and the battery includes an electrolyte and the non-aqueous solvent is the electrolyte.

8. The method of claim 2, wherein arranging a porous separator at least partially between the cathode electrode and the anode electrode comprises interleaving a cathode electrode within a first fold of the porous separator and interleaving an anode electrode within a second fold of the porous separator.

9. The method of claim 8, wherein dispensing the zeolite dispersion comprises spraying the zeolite dispersion on a first side of the porous separator that contacts the cathode electrode.

10. The method of claim 8, wherein dispensing the zeolite dispersion comprises spraying the zeolite dispersion on a second side of the porous separator that contacts the anode electrode.

11. The method of claim 9, wherein arranging a porous separator at least partially between the cathode electrode and the anode electrode comprises winding a first separator ribbon, a cathode electrode ribbon, a second separator ribbon, and an anode electrode ribbon around a mandrel.

12. The method of claim 11, wherein arranging a porous separator at least partially between the cathode electrode and the anode electrode comprises winding a first separator, a cathode electrode, a second separator, and an anode electrode around a mandrel.

13. The method of claim 12, wherein dispensing the zeolite dispersion comprises spraying the zeolite dispersion between the first separator and the cathode electrode, wherein the first separator is positioned between the cathode electrode and the anode electrode.

14. The method of claim 12, wherein dispensing the zeolite dispersion comprises spraying the zeolite dispersion between the first separator and the anode electrode.

15. The method of claim 1, further comprising placing the battery cell in a pouch; adding an electrolyte to the pouch; and sealing the pouch.

16. A secondary lithium ion battery cell for a vehicle, comprising:
a cathode electrode including a lithium and a transition metal;
an anode electrode;
a porous separator sandwiched between the cathode electrode and the anode electrode;
an electrolyte permeated in the porous separator and contacting the cathode electrode and anode electrode; and
a zeolite particle layer between the porous separator and at least one of the cathode electrode and the anode electrode, wherein the zeolite particle layer does not include a binder the zeolite particle layer in the battery cell.

17. The secondary lithium ion battery cell of claim 16, wherein the zeolite particle layer is in the range of 0.5 micrometers to 2 micrometers and exhibits a porosity in the range of 10 percent to 90 percent of the total volume defined by the zeolite particle layer.

18. The secondary lithium ion battery cell of claim 17, wherein the zeolite particle layer includes zeolite particles exhibit one or more specific surface areas, determined using BET (Brunauer, Emmett and Teller) theory technique, of over 100 meters squared per gram.

19. The secondary lithium ion battery cell of claim 18, wherein the zeolite exhibits the formula Mⁿ⁺_{1/n}(AlO₂)—(SiO₂)ₓ*yH2O, where Mⁿ⁺_{1/n} is one of a metal ion and a hydrogen ion, x is in the range of 1 to 30, n is the charge of the metal particle and may be in the range of 1 to 3 and y is in the range of 1 to 100.

20. A secondary lithium ion battery for a vehicle, comprising:
a casing;
one or more battery cells sealed in a pouch and stacked in the casing, wherein the battery cells include a cathode electrode including a cathode formed of lithium and a transition metal, an anode electrode, a porous separator sandwiched between the cathode electrode and the anode electrode, an electrolyte permeated in the porous separator and contacting the cathode electrode and anode electrode, and a zeolite particle layer between the porous separator and at least one of the cathode electrode and the anode electrode, wherein the zeolite particle layer does not include a binder for bonding the zeolite particle layer in the battery cell;
an anode tab connected to a portion of the anode electrode extending out of the pouch; and
a cathode tab connected to a portion of the cathode electrode extending out of the pouch.
